(19) United States
(12) Patent Application Publication
(10) Pub. No.: US 2026/0238298 A1
(43) Pub. Date: Aug. 13, 2026

(54) SSB TRANSMISSION FOR FAST UE BEAM TRACKING

(71) Applicant: Google LLC, Mountain View, CA (US)

(72) Inventors: Yushu ZHANG, Beijing (CN); Johg-Kae FWU, Sunnyvale, CA (US)

(21) Appl. No.: 19/150,788

(22) PCT Filed: Feb. 17, 2023
(86) PCT No.: PCT/CN2023/076875

§ 371 Date: Jul. 24, 2025

(51) Int. Cl. H04B 7/06

(52) U.S. Cl. CPC H04B 7/06952

(57) ABSTRACT

SSB transmission techniques for fast beam tracking are described herein. A UE (102) receives, from a network entity (104), a first SSB (306a, 606) and a second SSB (306b/308, 608) with a same spatial-domain transmission filter. The UE (102) communicates (312) a signal with the network entity (104) over a UE beam. The UE (102) selects the UE beam based on a joint beam tracking procedure (310, 610) that includes a beam quality comparison of a first beam (306a, 606) associated with the first SSB and a second beam (306b/308, 608) associated with the second SSB.

### TECHNICAL FIELD

The present disclosure relates generally to wireless communication, and more particularly, to synchronization signal block (SSB) transmissions for user equipment (UE) beam tracking.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a network entity periodically transmits synchronization signal blocks (SSBs) to the UE for the UE to perform beam quality measurements. However, increased latency may be caused by the UE having to perform multiple SSB measurement instances of the SSBs over a period of time. Additionally, activating multiple UE panels to simultaneously receive multiple SSBs from the network entity may result in increased power consumption by the UE.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, may use different network beams to transmit synchronization signal blocks (SSBs) to a user equipment (UE). A single SSB includes a primary synchronization signal (PSS), a secondary synchronization signal (SSS), and a physical broadcast channel (PBCH) signal. The network entity may transmit the SSBs to the UE periodically for the UE to perform a beam quality measurement.

A UE that is capable of analog beamforming may receive the SSBs from the network entity through a codebook-based UE beam search or a channel analysis-based UE beam search. For the codebook-based UE beam search, the UE maintains a plurality of UE beams for receiving the SSBs and selects a UE beam with a largest measured beam quality. Although simultaneous panel activation for receiving the SSBs may reduce a beam tracking latency, the UE may experience increased power consumption as a result of having multiple panels activated simultaneously. For the channel analysis-based UE beam search, the UE may receive an SSB on different symbols using different UE antennas and reconstruct the channel based on multiple measurement instances. However, the multiple measurement instances for the UE to identify the strongest beam may result in increased latency.

Aspects of the present disclosure address the above-noted and other deficiencies by implementing joint UE beam tracking techniques for faster UE beam tracking than channel analysis-based UE beam searches and with less power consumption costs than codebook-based UE beam searches. In some implementations, the UE performs the joint UE beam tracking procedure based on SSB repetitions of a same or different SSB. In other implementations, the UE performs the joint UE beam tracking based on a comparison of an SSB and a channel state information-reference signal (CSI-RS). Joint UE beam tracking is a procedure for the UE to identify a best/strongest UE beam to be associated with a network beam based on application of a same spatial-domain transmission filter to transmissions (e.g., SSB or CSI-RS) of the network entity. For single UE beam tracking, the UE may have to measure an SSB 8 times after receiving transmission configuration indicator (TCI) update signaling, whereas for joint UE beam tracking, the UE may only have to measure the SSB 4 times based on joint beam measurement instances by the UE. The joint UE beam tracking procedure may improve an overall beam management process, which may thereby reduce end-to-end delays.

According to some aspects, the UE receives, from the network entity, a first SSB and a second SSB based on a same spatial-domain transmission filter. The UE communicates a signal with the network entity over a UE beam, where a selection of the UE beam is based on the joint beam tracking procedure that includes a beam quality comparison of a first beam associated with the first SSB and a second beam associated with the second SSB.

According to some aspects, the network entity transmits, to the UE, the first SSB and the second SSB based on the same spatial-domain transmission filter, as described above. The network entity receives, from the UE, an indication of a UE beam for communicating with the network entity. The indication of the UE beam is based on the joint beam tracking procedure for the first beam associated with the first SSB and the second beam associated with the second SSB.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2B illustrate diagrams of example synchronization signal block (SSB) transmissions.

FIGS. 3A-3B illustrate signaling diagrams for fast beam tracking based on SSB transmissions.

FIG. 4 illustrates diagrams for UE beam tracking based on SSB repetitions.

FIG. 5 illustrates diagrams of SSB resources associated with repetition symbols.

FIG. 6 illustrates a signaling diagram for a UE beam tracking procedure based on SSB and channel state information-reference signal (CSI-RS) transmissions.

FIG. 7 illustrates a diagram of UE beam tracking resources associated with joint SSB/CSI-RS beam tracking of UE beams.

FIG. 8 illustrates a flowchart of a method of wireless communication at a UE.

FIG. 9 is a flowchart of a method of wireless communication at a network entity.

FIG. 10 is a diagram illustrating a hardware implementation for an example UE apparatus.

FIG. 11 is a diagram illustrating a hardware implementation for one or more example network entities.

### DETAILED DESCRIPTION

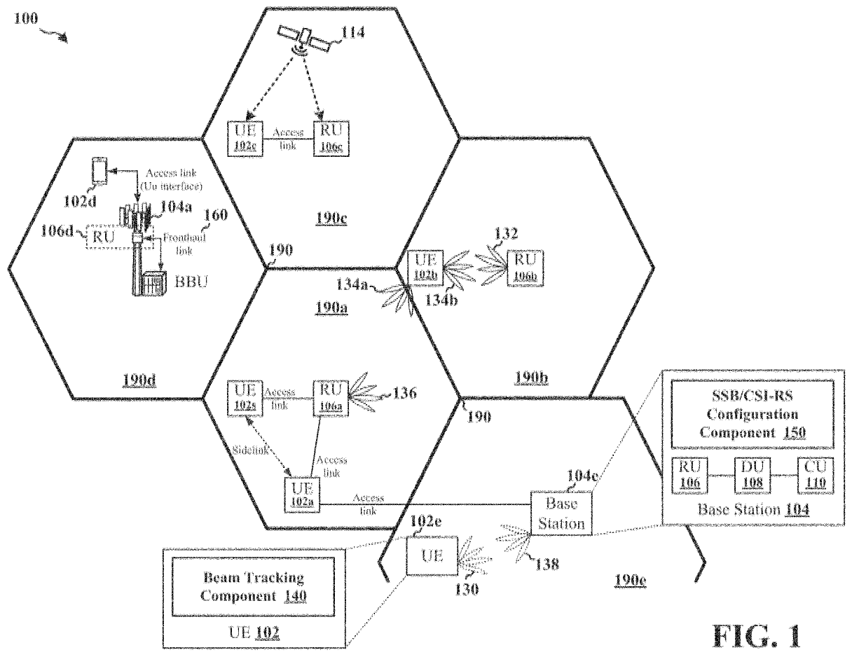

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the RUs 106a-106d may communicate with respective UEs 102a-102d and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104 of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHZ-71.0 GHz, which includes FR2-1 (24.25 GHz-52.6 GHZ) and FR2-2 (52.6 GHz-71.0 GHZ). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHZ-71.0 GHz, FR4, which ranges from 71.0 GHz-114.25 GHz, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station/RU 104a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, the UE 102 may include a beam tracking component 140 configured to receive, from a network entity, a first synchronization signal block (SSB) and a second SSB based on a same spatial-domain transmission filter; and communicate a signal with the network entity over a UE beam, a selection of the UE beam being based on a joint beam tracking procedure that includes a beam quality comparison of a first beam associated with the first SSB and a second beam associated with the second SSB.

In certain aspects, the base station 104 or a network entity of the base station 104 may include an SSB/channel state information-reference signal (CSI-RS) configuration component 150 configured to transmit, to a UE, a first SSB and a second SSB based on a same spatial-domain transmission filter; and receive, from the UE, an indication of a UE beam for communicating with the network entity, the indication of the UE beam being based on a joint beam tracking procedure of a first beam associated with the first SSB and a second beam associated with the second SSB.

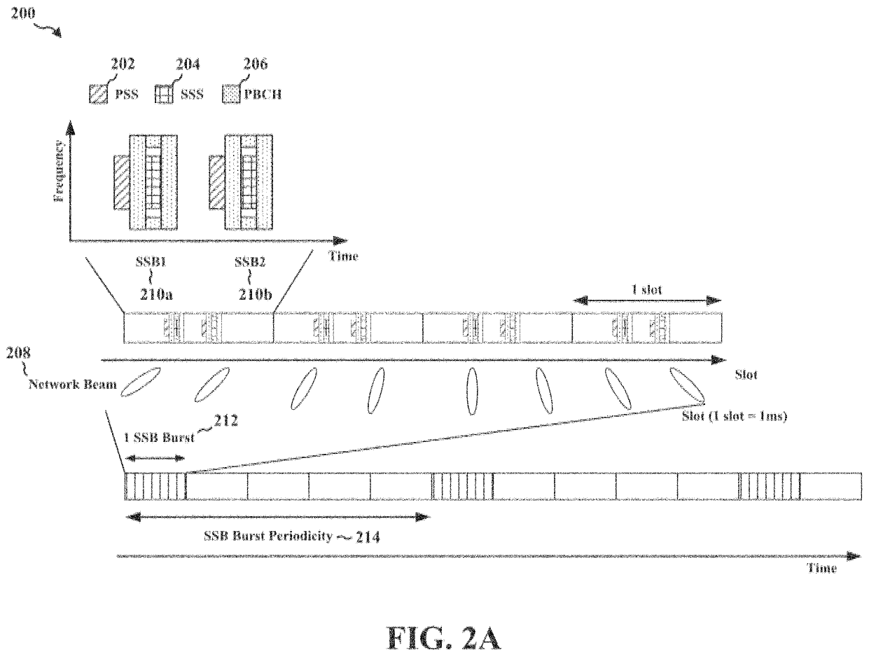

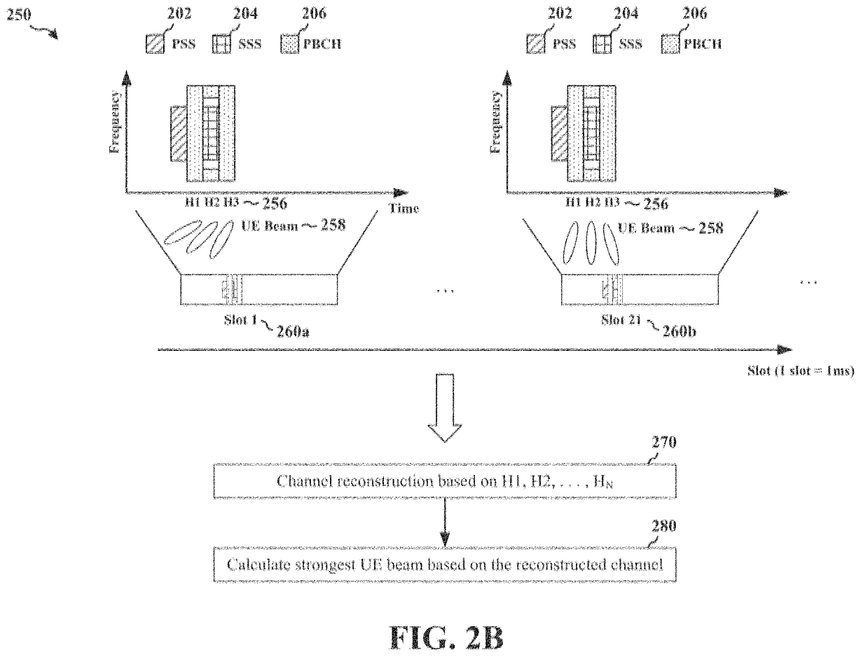

Accordingly, FIG. 1 describes a wireless communication system that may be implemented in connection with aspects of one or more other figures described herein, such as aspects illustrated in FIGS. 2-7. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 2A-2B illustrate diagrams 200-250 of example SSB transmissions. A network entity may use different network beams 208 to transmit SSBs 210 to a UE. A single SSB 210 includes a primary synchronization signal (PSS) 202, a secondary synchronization signal (SSS) 204, and a physical broadcast channel (PBCH) 206, such as illustrated via the time-frequency resources of the diagrams 200-250, where the vertical axis corresponds to the frequency domain and the horizontal axis corresponds to the time domain.

Each 1 millisecond (ms) slot may include a first SSB 210a and a second SSB 210b. The network entity transmits the SSBs 210 periodically via the network beams 208. In examples, the periodicity of the SSB transmissions occurs over a duration of 4 slots, which may comprise 1 SSB burst 212. A duration of the SSB burst 212 relative to an SSB burst periodicity 214 may correspond to a 1:5 ratio in time-domain. That is, for every 4 consecutive slots that comprise the SSB burst 212, there may be 16 subsequent slots (of 20 total slots in the SSB burst periodicity 214) that do not include an SSB burst 212. Thus, the overall periodicity for the SSB burst 212 is 20 ms.

The UE may perform an analog beamforming operation to receive the SSB(s) 210 from the network entity, where a downlink signal reception of a network beam 208 by the UE may be based on a codebook-based UE beam search or a channel analysis-based UE beam search. For the codebook-based UE beam search, the UE maintains a plurality of UE beams for receiving the SSB 210. For example, the UE receives the SSB 210 with different UE beams and selects a UE beam from the plurality of UE beams with a largest measured beam quality (e.g., a largest layer 1-reference signal received power (L1-RSRP)). The UE may perform a symbol-level beam sweeping/scan for the SSBs 210 to identify the largest quality UE beam. However, in some cases, the UE may be limited to 3 or 4 UE beams measurement instances per SSB occasion. For example, with only 3 different PSS sequences being predefined for the UE, the PSS symbol may not be applicable to the UE beam sweeping procedure. Hence, the UE would have to measure one or more remaining beams during a next SSB occasion.

In the diagram 250 of FIG. 2B, where 1 slot is equal to 1 ms, a periodicity of the SSB occasion from slot 1 260a to slot 21 260b is 20 ms. For a codebook-based beam search, if the UE has 8 beams and 3 panels and activates one panel at a time, the UE can measure 3 UE beams 258 per SSB occasion for the beam search procedure. Since the UE has to measure the SSB 8 times for the 8 different UE beams 258, a latency of the beam search procedure for identifying the strongest UE beam 258 is 160 ms (e.g., 8 SSB measurement instances×20 ms periodicity). In another example, where the UE still has 8 beams to measure and 3 panels, but the UE is able to activate all 3 panels simultaneously, the UE can measure 3 UE beams 258 per SSB occasion for the beam search procedure. For example, the UE has 3 measurement occasions based on SSB ceil (8/3)=3, such that the latency of the beam search procedure for identifying the strongest UE beam 258 is reduced to 60 ms (e.g., 3 SSB measurement occasions×20 ms periodicity). Although a beam tracking latency for simultaneous panel activation is reduced in comparison to individual panel activations, the UE may experience increased power consumption as a result of having to simultaneously activate multiple panels.

For a channel analysis-based beam search, the UE may receive the SSB 210 on different symbols based on different UE antennas and reconstruct the channel 256 using the multiple measurement instances. For example, the UE calculates an eigenvector for the reconstructed channel and selects a first row of the eigenvector as corresponding to the strongest UE beam. Due to the UE using different antennas to receive the SSB 210 at different measurement occasions, the channel H for each measurement instance from a UE antenna j may be indicated as Hj, such that the UE can reconstruct 270 the channel 256 based on:

$$H = [ {H}_{1} , {H}_{2} , … , {H}_{N} ]$$

where N corresponds to a number of antenna elements for a UE panel. The UE may then calculate the eigenvector of the reconstructed channel based on:

$${USV}^{H} = {H}^{H} H$$

where U is the left singular matrix, S is a diagonal matrix with singular values, and V is the right singular matrix. The UE selects the first row of matrix V as a calculation 280 of the strongest UE beam based on the reconstructed channel. A similar approach may be applicable to devices with multiple receiver chains.

An increase in latency for the UE to identify the strongest beam may result from the channel analysis-based beam search being based on multiple SSB measurement occasions. For example, if the UE has 3 panels with 4 antennas per panel and 1 port, the UE may scan for/receive the SSB 4 times using the 12 antennas in rotation. If the SSB periodicity is 20 ms, an overall delay for the channel analysis-based beam search is 80 ms (e.g., 4 SSB measurement occasions×20 ms periodicity). However, a phase noise may cause a phase error in the estimated/reconstructed 270 channel if a measurement gap between the measurement occasions becomes too large (e.g., greater than 1 or 2 slots).

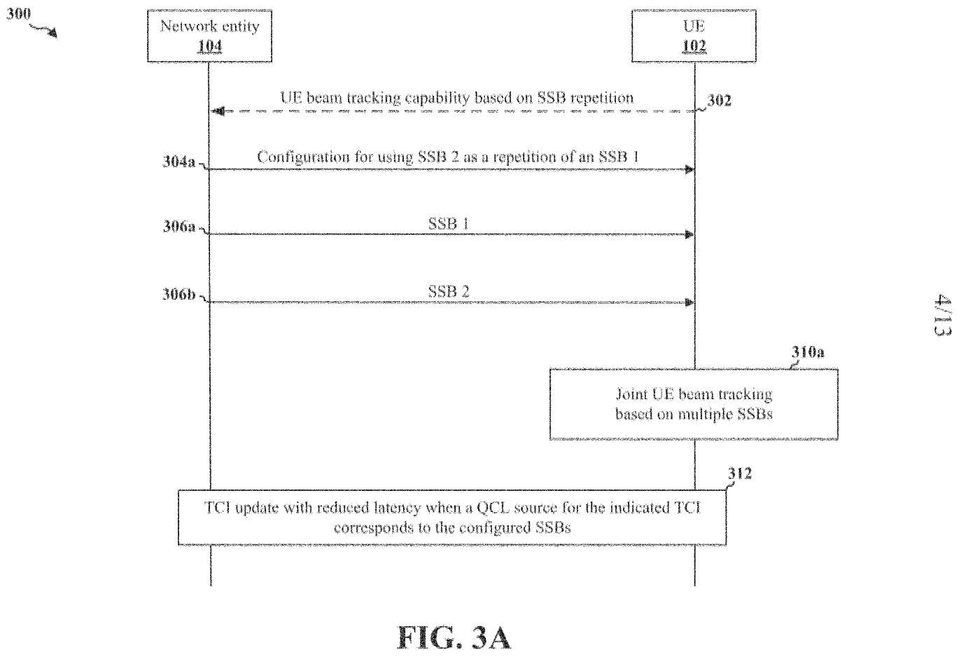

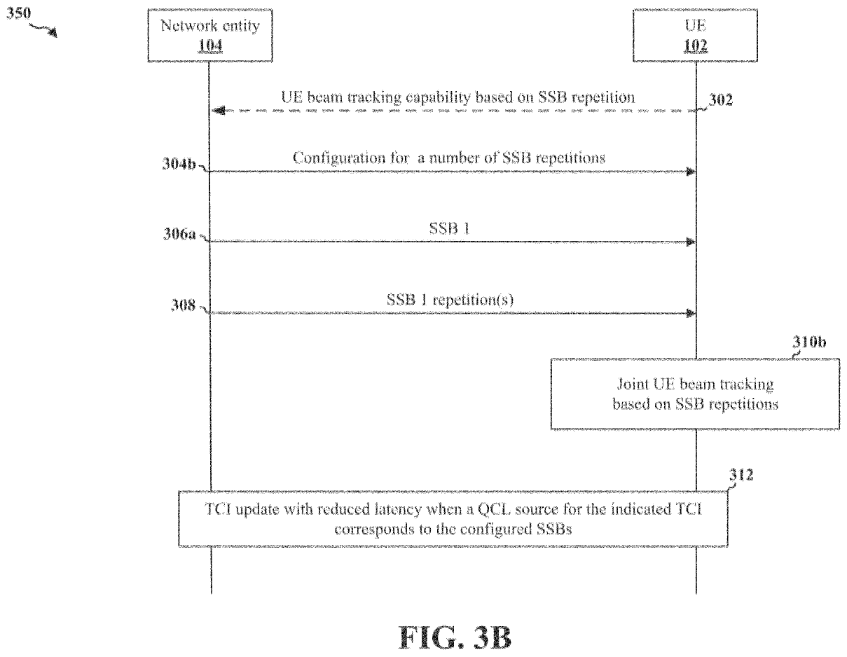

Accordingly, the UE may implement techniques with decreased latency for UE beam tracking based on SSB transmissions. The decreased latency may be provided via an SSB framework for intra-symbol beam tracking, SSB repetition for UE beam tracking, and/or joint SSB and CSI-RS-based UE beam tracking. The reduced UE beam tracking latency may improve an overall beam management process, which may thereby reduce end-to-end delays. FIGS. 2A-2B show SSB transmission schemes. FIGS. 3A-3B describe UE beam tracking based on repetitions of SSBs.

FIGS. 3A-3B illustrate signaling diagrams 300-350 for fast beam tracking based on SSB transmissions. More specifically, FIG. 3A illustrates joint beam tracking based on using an SSB 2 as a repetition of an SSB 1, whereas FIG. 3B illustrates joint beam tracking based on repetitions of SSB 1.

The UE 102 may report 302, to the network entity 104, a UE beam tracking capability based on SSB repetition. That is, the UE 102 may indicate to the network entity 104 whether the UE 102 supports UE beam tracking across SSBs. In some implementations, the network entity 104 may receive an indication of the UE beam tracking capability from a core network (e.g., an access and mobility management function (AMF)). In other implementations, the network entity 104 may receive the indication of the UE beam tracking capability from another base station/network entity, such as a gNB, an eNB, or a 6G base station/network entity. The UE capability may also indicate a minimum number of SSB repetitions for a UE beam sweeping/scanning procedure and/or whether the UE 102 supports cross-component carrier SSB repetitions for the UE beam tracking. The UE 102 may report 302 the UE capability per feature set, per band, per band combination, and/or per UE.

In FIG. 3A, the network entity 104 transmits 304a control signaling to the UE 102 that configures the UE 102 to receive 306b at least a second SSB as a repetition of a first SSB. For instance, SSB 1 and SSB 2 may share a same spatial domain transmission filter. That is, SSB 1 and SSB 2 are transmitted using a same network beam. In FIG. 3B, the network entity 104 transmits 304b the control signaling to configure the UE 102 to receive 308 SSB repetition(s) of a same SSB. For instance, SSB 1 and SSB 1 repetition(s) may share a same spatial domain transmission filter.

The network entity 104 may indicate 304 the configurations via RRC signaling (e.g., an RRCReconfiguration message, a system information block (SIB), or a master information block (MIB)) or via a medium access control-control element (MAC-CE) or downlink control information (DCI). The network entity 104 may transmit the MAC-CE or DCI using groupcast techniques (e.g., based on a radio network temporary identifier (RNTI) that is predefined or configured by the network entity 104 through RRC signaling). In other examples, the network entity 104 transmits the MAC-CE or DCI using UE-dedicated signaling (e.g., based on a cell-RNTI (C-RNTI) for individual UEs 102).

In FIG. 3A, the network entity 104 transmits 306a-306b SSB 1 and SSB2 with the same spatial domain filter when the UE 102 is configured to receive 306b SSB 2 as a repetition of SSB 1. In FIG. 3B, the network entity 104 transmits 308 SSB 1 repetition(s) to the UE 102 when the UE 102 is configured to receive 308 SSB 1 repetition(s) of the SSB 1. The network entity 104 can configure 304 the UE 102 for a number of repetitions of a same SSB. The network entity 104 transmits 308 the SSB repetition(s) of the same SSB (e.g., SSB 1) with the same spatial domain transmission filter.

The UE 102 performs 310a-310b joint UE beam tracking based on SSB repetitions. SSB repetition, as used herein, can refer to either a repetition of a same SSB (e.g., SSB 1 and SSB 1 repetition(s), as illustrated in FIG. 3B) or a second SSB being used as a repetition of a first SSB (e.g., SSB 1 and SSB 2, as illustrated in FIG. 3A). Hence, the joint UE beam tracking may be performed 310a based on multiple SSBs (e.g., SSB 1 and SSB 2), or the joint UE beam tracking may be performed 310b based on a repetition of SSB 1. In other examples, the joint UE beam tracking may be performed based on a combination of multiple SSBs and repetition of an SSB.

The UE 102 may apply the joint UE beam tracking across repetitions to identify a strongest UE beam associated with the network beam used for transmission 306a-306b of SSB 1 and SSB 2, or used for transmission 306a/308 of SSB 1 and SSB 1 repetitions. If the network entity 104 provides transmission configuration indicator (TCI) update signaling with SSB 1 or SSB 2 as a quasi-co-location (QCL) source, the UE 102 may implement a delay in updating the TCI when the joint SSBs are being used for UE beam tracking.

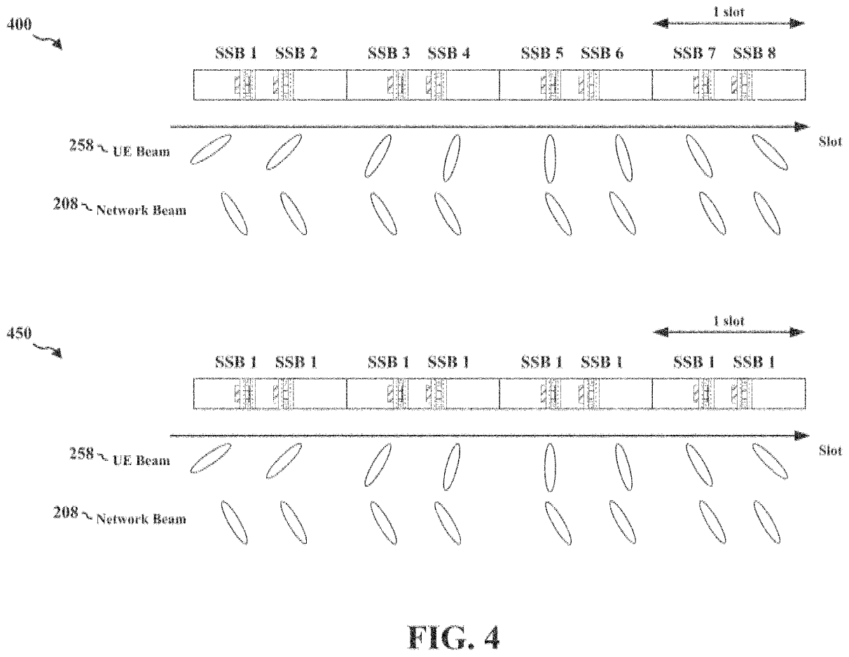

For single SSB UE beam tracking, if the indicated TCI is initially undetermined, the UE 102 may measure the single SSB 8 times upon receiving the TCI update signaling prior to a TCI application time, whereas for joint SSB UE beam tracking, the UE 102 measures the SSBs 4 times prior to the TCI application time. Accordingly, the network entity 104 and the UE 102 may perform 312 a TCI update procedure with reduced latency when the QCL source for the indicated TCI corresponds to the configured SSB(s). For channel analysis-based UE beam searches, the network entity 104 may be able to maintain phase continuity for signals in each symbol and each repetition of the SSB. FIGS. 3A-3B illustrate signaling procedures for SSB repetition techniques, whereas FIG. 4 shows different SSB transmission patterns for the SSB repetition techniques.

FIG. 4 illustrates diagrams 400-450 for UE beam tracking based on SSB repetitions. The network entity may transmit control signaling to the UE indicating a repetition scheme across SSBs. The network entity can configure one or more SSB repetition sets, where each SSB repetition set corresponds to an index of SSBs that share the same spatial domain transmission filter. Each SSB repetition set may also correspond to a serving cell index of each SSB for cross-component carrier SSB repetitions. In other implementations, the network entity may configure the repetition set index for each SSB, and the repetition set index may be defined per serving cell, per serving cell group, or per UE. SSBs that have the same repetition set index are associated with the same spatial domain filter.

The diagram 400 illustrates tracking UE beams 258 based on an SSB repetition set with 8 SSBs. The network entity uses network beams 208 to transmit one or more SSB repetitions, such as within a same slot or different slots, within an SSB burst. The SSB burst may correspond to 4 consecutive slots that include the 8 SSBs. For example, the network entity transmits SSB 1 and SSB 2 in a first same slot using a first same network beam (e.g., same spatial domain transmission filter), transmits SSB 3 and SSB 4 in a second same slot using a second same network beam, transmits SSB 5 and SSB 6 in a third same slot using a third same network beam, and transmits SSB 7 and SSB 8 in a fourth same slot using a fourth same network beam. The UE may use different UE beams for receiving SSBs in a same slot. For example, the UE may use a first UE beam for receiving SSB 1 and a second UE beam for receiving SSB 2 based on the joint beam tracking procedure. The network entity may also use the network beams 208 to transmit the SSB repetitions in the same or different serving cells. The network entity can transmit the SSB repetitions uniformly or non-uniformly. “Uniform” SSB repetitions refers to SSBs transmitted across multiple slots that correspond to same time-frequency resources relative to each of the multiple slots.

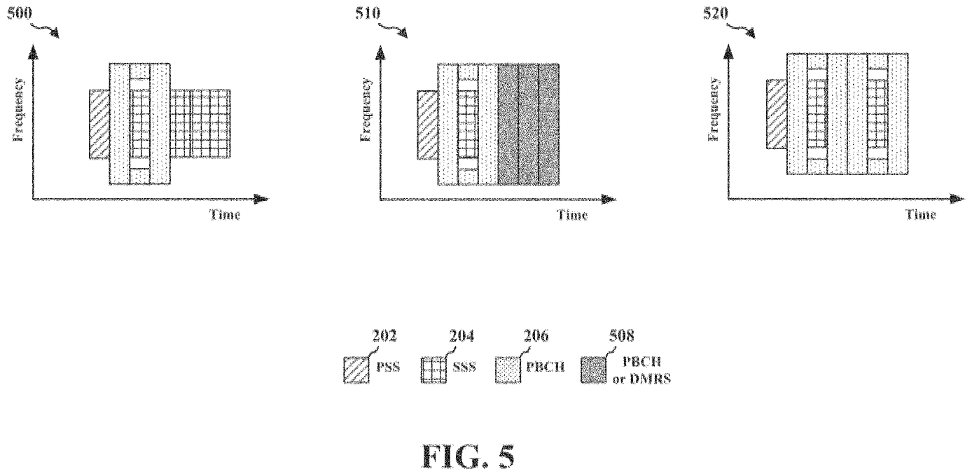

The diagram 450 illustrates tracking UE beams 258 based on 8 repetitions of a same SSB via the network beams 208. For example, the network entity uses the network beams 208 to transmit SSB 1 on 8 different occasions over the 4 consecutive slots of the SSB burst. The UE may use different UE beams for receiving the SSB repetitions based on the joint beam tracking procedure. The SSB repetitions may be in the same or different serving cells and transmitted uniformly or non-uniformly. The configuration for the UE may include parameters that enable or disable SSB repetitions for all SSBs or each SSB. The parameters may also indicate a number of repetitions for all SSBs or each SSB, a symbol and/or slot offset between every two consecutive repetitions for all SSBs or each SSB, a location (e.g., starting symbol and/or slot index) of each repetition for each SSB, and/or a periodicity of each SSB or each SSB repetition. The parameters may be defined per SSB, for SSBs in a serving cell, or for SSBs in a serving cell group. Some parameters may be predefined (e.g., the number of repetitions for an SSB=4; the symbol offset between every two consecutive repetitions for an SSB=1; the slot offset between every two consecutive repetitions for an SSB=0; etc.). FIG. 4 illustrates SSB repetitions, whereas FIG. 5 illustrates SSB structures associated with the SSB repetitions.

FIG. 5 illustrates diagrams 500-520 of SSB resources associated with repetition symbols. For example, in the diagram 500, the network entity transmits one or more repetitions (e.g., 4 repetitions) of SSS 204 for an SSB. The network entity may transmit the SSS repetitions in one or more slots within an SSB burst, where the SSS repetitions may be uniformly distributed or non-uniformly distributed. Control signaling for the SSS repetitions may indicate parameters that enable or disable the SSS repetitions for the SSBs. The parameters may also indicate a number of SSS repetitions for the SSBs, a symbol and/or slot offset between every two consecutive SSS repetitions for the SSBs, and/or a location (e.g., starting symbol and/or slot index) of each SSS repetition for each SSB. Some of the parameters may be predefined, as similarly described with respect to the diagram 650.

In the diagram 510, the network entity transmits one or more repetitions on the PBCH 206 or one or more repetitions of the demodulation reference signal (DMRS) 508 for the PBCH for the SSB. The network entity may transmit repetitions on the PBCH 206 or repetitions of the PBCH-DMRS 508 in one or more slots within the SSB burst, which may be uniformly or non-uniformly distributed. In some examples, the network entity repeats part of the PBCH 206 or part of the PBCH-DMRS 508, such as the last symbol of the PBCH or PBCH-DMRS 508 from the second PBCH repetitions. Control signaling for the PBCH repetitions or the PBCH-DMRS repetitions may indicate parameters that enable or disable the repetitions for the SSBs. The parameters may also indicate a number of PBCH repetitions or PBCH-DMRS repetitions for the SSBs, a symbol and/or slot offset between every two consecutive PBCH repetitions or PBCH-DMRS repetitions for the SSBs, and/or a location (e.g., starting symbol and/or slot index) of each PBCH repetition or PBCH-DMRS repetition for the SSBs.

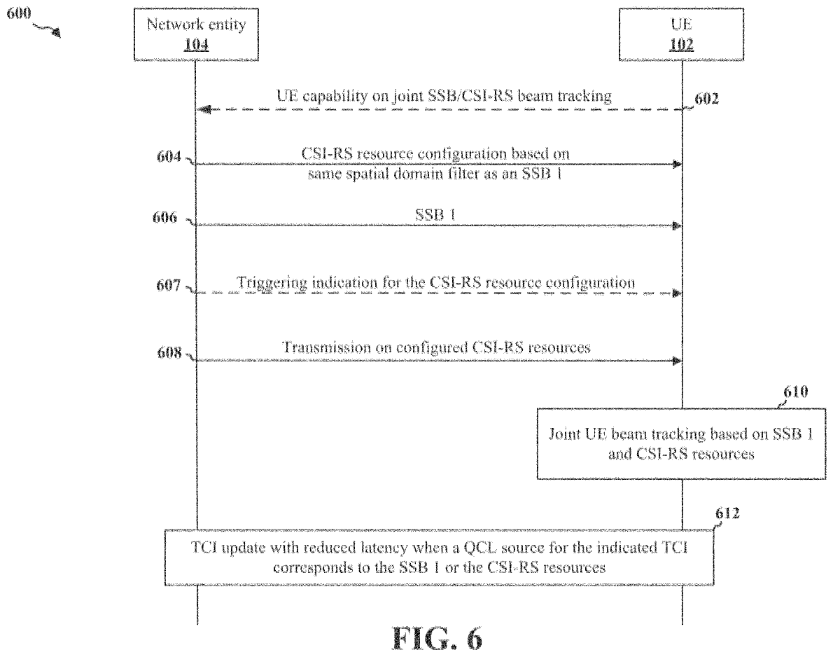

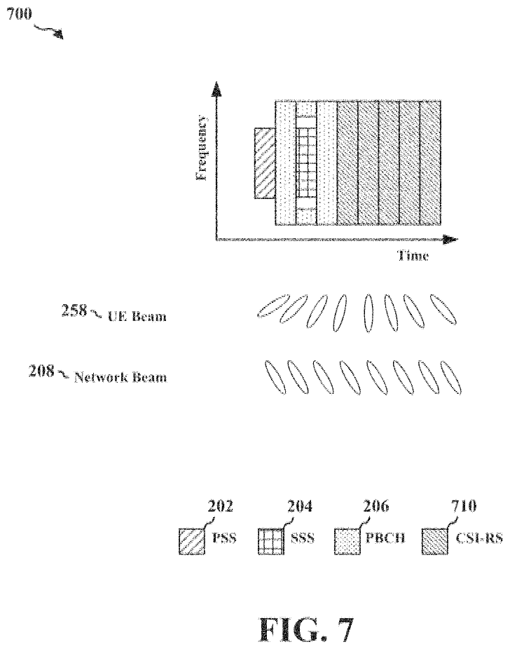

In the diagram 520, the network entity transmits, for an SSB, one or more repetitions of the SSS 204 and the PBCH 206, which may correspond to the SSS 204 and the PBCH-DMRS 508 in some examples. The network entity may transmit the SSS/PBCH repetitions in one or more slots within the SSB burst, which may be uniformly or non-uniformly distributed. In examples, the network entity repeats at least a portion of the PBCH 206 or the PBCH-DMRS 508 for the SSS/PBCH repetition. Control signaling for the SSS/PBCH repetition may indicate parameters that enable or disable the SSS/PBCH repetition for the SSBs. The parameters may also indicate a number of SSS/PBCH repetitions for the SSBs, a symbol and/or slot offset between every two consecutive SSS/PBCH repetitions for the SSBs, and/or a location (e.g., starting symbol and/or slot index) of each SSS/PBCH repetition for the SSBs. Although the diagrams 500-520 show repetition of various portions of an SSB, it is understood that these patterns are examples and that other examples may be used such as repetitions of other portions of the SSB (e.g., PSS 202) or combinations of repetitions of SSB components (e.g., SSS 204 and DMRS, etc.). FIGS. 3A-5 describe joint UE beam tracking based on SSB repetitions, whereas FIGS. 6-7 describe joint UE beam tracking based on a multiplexing SSB and CSI-RS resources.

FIG. 6 illustrates a signaling diagram 600 for a UE beam tracking procedure based on SSB and CSI-RS transmissions. The SSB and the CSI-RS may be associated with a same spatial domain filter. The UE 102 may report 602, to the network entity 104, a UE capability of the UE 102 for joint SSB/CSI-RS beam tracking. That is, the UE 102 may indicate to the network entity 104 whether the UE 102 supports UE beam tracking based on joint SSB/CSI-RS reception from the network entity 104. In some implementations, the network entity 104 may receive an indication of the UE capability from the core network. In other implementations, the network entity 104 may receive the indication of the UE capability from another base station/network entity. The UE capability may also indicate a minimum number of CSI-RS resources for performing a UE beam sweeping/scanning procedure and/or whether the UE 102 supports cross-component carrier UE beam tracking based on joint SSB/CSI-RS techniques. The UE 102 may report 602 the UE capability per feature set, per band, per band combination, and/or per UE.

The network entity 104 transmits 604 a configuration for a CSI-RS resource/resource set based on a same spatial domain transmission filter as the SSB 1. In some examples, the network entity 104 transmits 604 the configuration responsive to the UE capability received 602 from the UE 102. The network entity 104 may indicate 604 the configuration through control signaling, such as RRC signaling (e.g., RRCReconfiguration, SIB, or MIB) or through the MAC-CE or DCI. The network entity 104 may transmit the MAC-CE or DCI using groupcast techniques (e.g., based on a RNTI that is predefined or configured by the network entity 104 through RRC signaling). In other examples, the network entity 104 transmits the MAC-CE or DCI using UE-dedicated signaling (e.g., based on a C-RNTI for each UE 102).

The network entity 104 transmits 606 the SSB 1 to the UE 102 for the joint SSB/CSI-RS beam tracking procedure. In some examples, the network entity 104 transmits 607 a triggering indication for the CSI-RS resource configuration associated with the joint SSB/CSI-RS beam tracking procedure. The network entity 104 performs a transmission 608 to the UE 102 on the configured CSI-RS resource(s) based on the same spatial domain filter as used for the transmission 606 of the SSB 1. The UE 102 performs 610 the joint UE beam tracking based on the SSB 1 and the configured CSI-RS resource(s) to identify a UE beam to pair with the network beam used for the SSB 1 and the CSI-RS resource(s).

The network entity 104 and the UE 102 may perform 612 a TCI update procedure with reduced latency when the QCL source for the indicted TCI corresponds to the SSB 1 or the CSI-RS resource(s). If the network entity 104 indicates a TCI update with the SSB 1 or the CSI-RS resource(s) as the QCL source, the UE 102 can apply a delay to updating the TCI based on the joint SSB/CSI-RS beam tracking. For single SSB beam tracking, if the indicated TCI is undetermined, the UE 102 measures the single SSB 8 times upon receiving the TCI update signaling prior to a TCI application time, whereas for joint SSB/CSI-RS beam tracking, the UE 102 only receives the SSB once before the TCI application time when 7 CSI-RS resources are configured by the network entity 104. For channel analysis-based UE beam searches, the network entity 104 may be able to maintain a phase continuity for the SSB/CSI-RS joint beam tracking procedure. FIG. 6 illustrates signaling procedures for beam tracking based on SSB/CSI-RS multiplexing techniques, whereas FIG. 7 illustrates multiplexed SSB/CSI-RS resources.

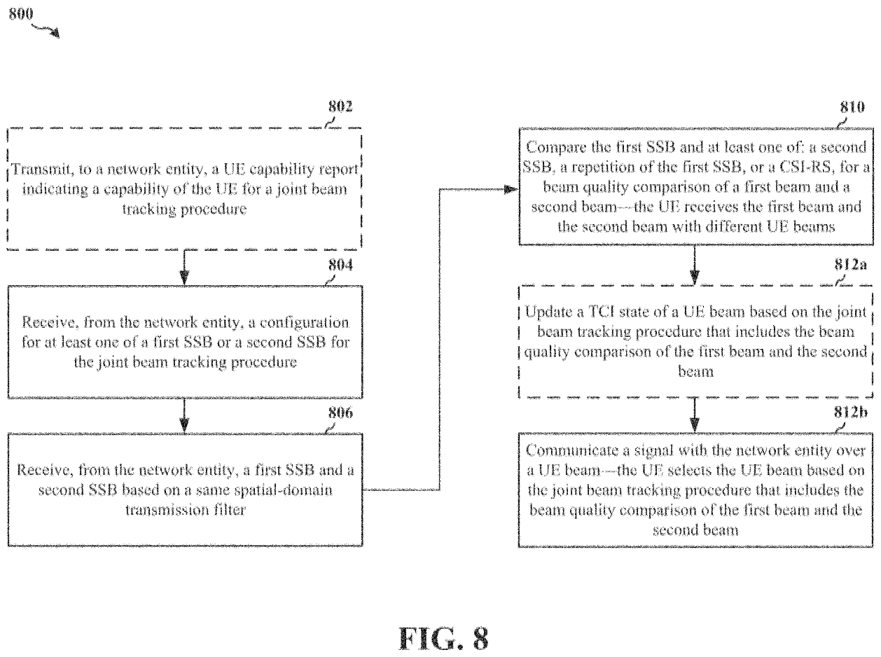

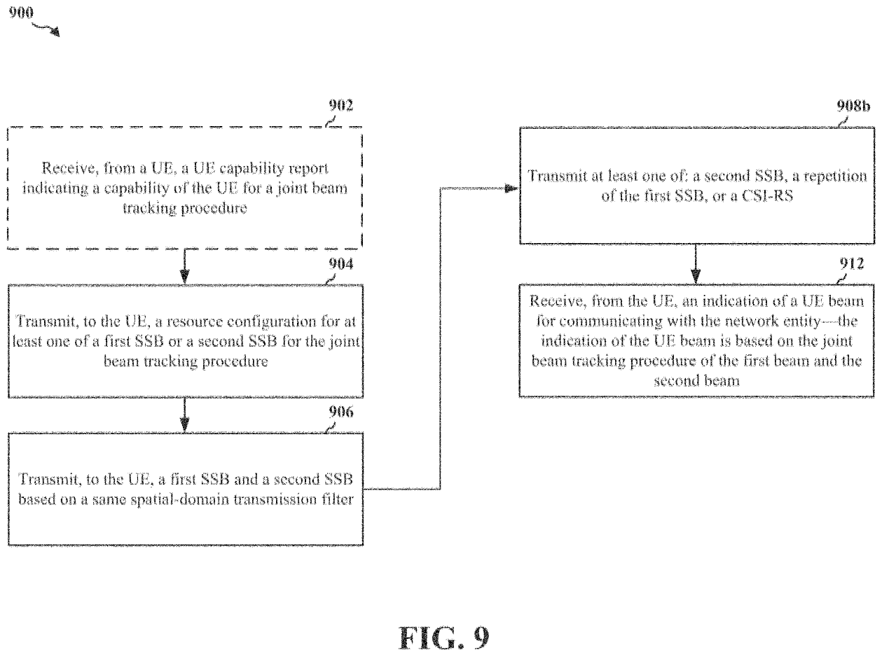

FIG. 7 illustrates a diagram 700 of UE beam tracking resources associated with joint SSB/CSI-RS beam tracking of UE beams 258. In particular, the network entity may transmit network beams 208 that include CSI-RS 710 on resources associated with the PSS 202, SSS 204, and PBCH 206 resources of an SSB. The network entity configures the SSB and the CSI-RS resource(s), such that the network entity may transmit the SSB and the CSI-RS 710 using the same spatial domain filter. The network entity may also configure an SSB index based on a same serving cell for the CSI-RS resource(s). The network entity may likewise configure a serving cell index for the CSI-RS resource/resource set. The network entity multiplexes the CSI-RS 710 and the SSB using time-domain multiplexing (TDM) techniques. The CSI-RS 710 and the SSB may include a same or different subcarrier spacing. FIGS. 3-7 describe joint UE beam tracking. FIGS. 8-9 show methods for implementing one or more aspects of FIGS. 3-7. In particular, FIG. 8 shows an implementation by the UE 102 of the one or more aspects of FIGS. 3-7. FIG. 9 shows an implementation by the network entity 104 of the one or more aspects of FIGS. 3-7.

FIG. 8 illustrates a flowchart 800 of a method of wireless communication at a UE. With reference to FIGS. 3A-3B, 6, and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006.

The UE 102 transmits 802, to a network entity, a UE capability report indicating a capability of the UE for a joint beam tracking procedure. For example, referring to FIGS. 3A-3B, the UE 102 reports 302 a UE beam tracking capability based on SSB repetition. Referring to FIG. 6, the UE 102 reports 602 a UE capability on joint SSB/CSI-RS beam tracking.

The UE 102 receives 804, from the network entity, a configuration for at least one of a first SSB or a second SSB for the joint beam tracking procedure. For example, referring to FIG. 3A, the UE 102 receives 304a a configuration for using SSB 2 as a repetition of SSB 1. Referring to FIG. 3B, the UE 102 receives 304b a configuration for a number of SSB repetitions. Referring to FIG. 6, the UE 102 receives 604 a CSI-RS resource configuration based on a same spatial-domain transmission filter as SSB 1.

The UE 102 receives 806, from the network entity, a first SSB and a second SSB based on a same spatial-domain transmission filter, as illustrated in FIGS. 4, 5, and 7. Referring to FIGS. 3A-3B and 6, the UE 102 receives 306a/606 SSB 1 from the network entity 104. Referring to FIG. 3A, the UE 102 receives 306b SSB 2 as a repetition of SSB1. Referring to FIG. 3B, the UE 102 receives 308 SSB 1 repetition(s) from the network entity 104. Referring to FIG. 6, the UE 102 receives 608 a CSI-RS transmission on configured CSI-RS resources with the same spatial domain transmission filter as SSB 1.

The UE 102 compares 810 the first SSB and at least one of: a second SSB, a repetition of the first SSB, or a CSI-RS, for a beam quality comparison of a first beam and a second beam—the UE receives the first beam and the second beam with different UE beams. For example, referring to FIG. 3A, the UE 102 performs 310a joint UE beam tracking based on multiple SSBs (e.g., based on a comparison of SSB 1 and SSB 2). Referring to FIG. 3B, the UE 102 performs 310b joint UE beam tracking based on SSB repetitions (e.g., based SSB 1 repetitions 308). Referring to FIG. 6, the UE 102 performs 610 joint UE beam tracking based on SSB 1 and the CSI-RS transmission on the CSI-RS resources.

The UE 102 updates 812a a TCI state of a UE beam based on the joint beam tracking procedure that includes the beam quality comparison of the first beam and the second beam. For example, referring to FIGS. 3A-3B, the UE 102 updates 312, based on the joint UE beam tracking procedure 310, the TCI state with reduced latency when the QCL source for the indicated TCI corresponds to the configured SSBs. Referring to FIG. 6, the UE 102 updates 612, based on the joint UE beam tracking procedure 610, the TCI state with reduced latency when the QCL source for the indicated TCI corresponds to the SSB 1 or the CSI-RS resources.

The UE 102 communicates 812b a signal with the network entity over a UE beam—the UE selects the UE beam based on the joint beam tracking procedure that includes the beam quality comparison of the first beam and the second beam. For example, referring to FIGS. 3A-3B and 6, the UE 102 selects a UE beam based on the joint beam tracking procedure 310/610 and communicates 312/612 with the network entity 104 using the UE beam based on the TCI update. For instance, the UE 102 may receive a downlink transmission (e.g., a physical downlink control channel (PDCCH) transmission, a physical downlink shared channel (PDSCH) transmission, etc.) from the network entity 104 using the selected UE beam. FIG. 8 describes a method from a UE-side of a wireless communication link, whereas FIG. 9 describes a method from a network-side of the wireless communication link.

FIG. 9 is a flowchart 900 of a method of wireless communication at a network entity. With reference to FIGS. 3A-3B, 6, and 11, the method may be performed by one or more network entities 104, which may correspond to a base station or a unit of the base station, such as the RU 106, the DU 108, the CU 110, an RU processor 1106, a DU processor 1126, a CU processor 1146, etc. The one or more network entities 104 may include memory 1106′/1126′/1146′, which may correspond to an entirety of the one or more network entities 104, or a component of the one or more network entities 104, such as the RU processor 1106, the DU processor 1126, or the CU processor 1146.

The network entity 104 receives 902, from a UE, a UE capability report indicating a capability of the UE for a joint beam tracking procedure. For example, referring to FIGS. 3A-3B, the network entity 104 receives 302, from the UE 102, a UE beam tracking capability based on SSB repetition. Referring to FIG. 6, the network entity 104 receives 602, from the UE 102, a UE capability on joint SSB/CSI-RS beam tracking.

The network entity 104 transmits 904, to the UE, a resource configuration for at least one of a first SSB or a second SSB for the joint beam tracking procedure. For example, referring to FIG. 3A, the network entity 104 transmits 304a a configuration for using SSB 2 as a repetition of SSB 1. Referring to FIG. 3B, the network entity 104 transmits 304b a configuration for a number of SSB repetitions. Referring to FIG. 6, the network entity 104 transmits 604 a CSI-RS resource configuration based on a same spatial-domain transmission filter as SSB 1.

The network entity 104 transmits 906, to the UE, a first SSB and a second SSB based on a same spatial-domain transmission filter, as illustrated in FIGS. 4, 5, and 7. Referring to FIGS. 3A-3B and 6, the network entity 104 transmits 306a/606 SSB 1 as the first beam to the UE 102. Referring to FIG. 3A, the network entity 104 transmits 306b SSB 2 as a repetition of SSB1. Referring to FIG. 3B, the network entity 104 transmits 308 SSB 1 repetition(s) to the UE 102. Referring to FIG. 6, the network entity 104 transmits 608 a CSI-RS transmission on configured CSI-RS resources with the same spatial domain transmission filter as SSB 1.

The network entity 104 transmits 908b at least one of: a second SSB, a repetition of the first SSB, or a CSI-RS. For example, referring to FIG. 3A, the network entity 104 transmits 306b, to the UE 102, SSB 2 as a repetition of SSB1. Referring to FIG. 3B, the network entity 104 transmits 308 SSB 1 repetition(s) to the UE 102. Referring to FIG. 6, the network entity 104 transmits 608, to the UE 102, a CSI-RS transmission on configured CSI-RS resources with the same spatial domain transmission filter as SSB 1.

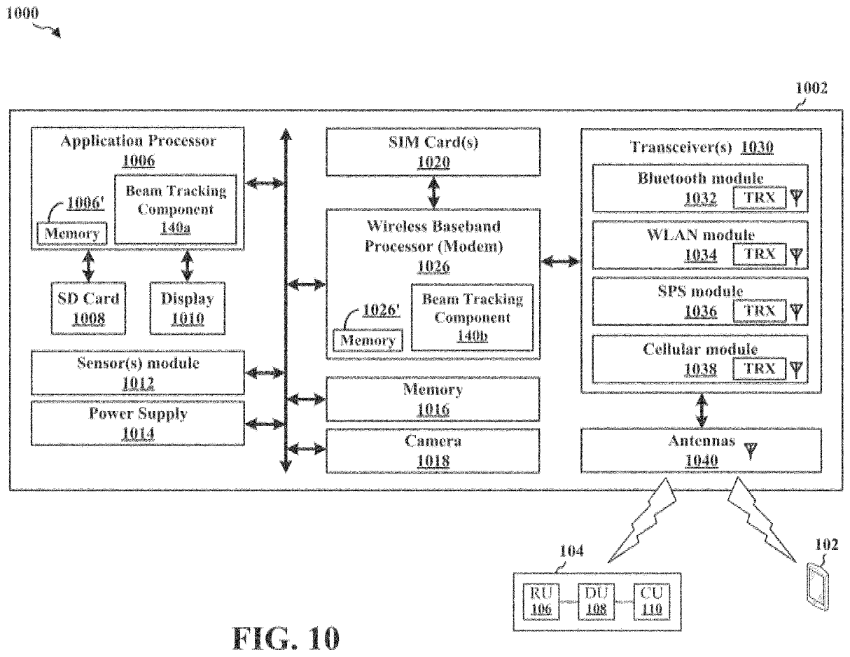

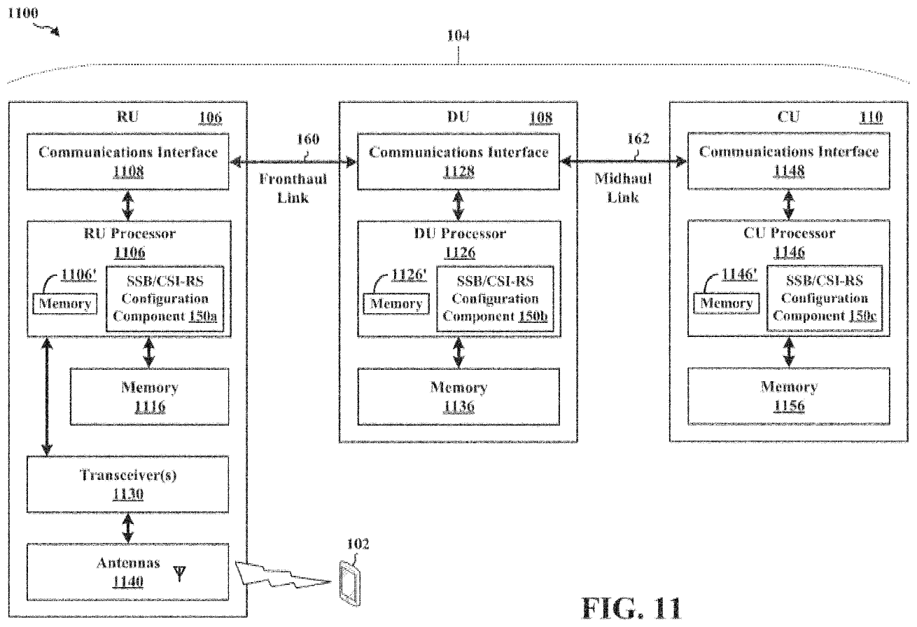

The network entity 104 receives 912, from the UE, an indication of a UE beam for communicating with the network entity—the indication of the UE beam is based on the joint beam tracking procedure of the first beam and the second beam. For example, referring to FIGS. 3A-3B and 6, the network entity 104 receives, based on the joint beam tracking procedure 310/610, an indication of a selected UE beam for communicating 312/612 with the network entity 104 using the UE beam based on the TCI update. A UE apparatus 1002, as described in FIG. 10, may perform the method of flowchart 800. The one or more network entities 104, as described in FIG. 11, may perform the method of flowchart 900.

FIG. 10 is a diagram 1000 illustrating an example of a hardware implementation for a UE apparatus 1002. The UE apparatus 1002 may be the UE 102, a component of the UE 102, or may implement UE functionality. The UE apparatus 1002 may include an application processor 1006, which may have on-chip memory 1006′. In examples, the application processor 1006 may be coupled to a secure digital (SD) card 1008 and/or a display 1010. The application processor 1006 may also be coupled to a sensor(s) module 1012, a power supply 1014, an additional module of memory 1016, a camera 1018, and/or other related components. For example, the sensor(s) module 1012 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1002 may further include a wireless baseband processor 1026, which may be referred to as a modem. The wireless baseband processor 1026 may have on-chip memory 1026′. Along with, and similar to, the application processor 1006, the wireless baseband processor 1026 may also be coupled to the sensor(s) module 1012, the power supply 1014, the additional module of memory 1016, the camera 1018, and/or other related components. The wireless baseband processor 1026 may be additionally coupled to one or more subscriber identity module (SIM) card(s) 1020 and/or one or more transceivers 1030 (e.g., wireless RF transceivers).

Within the one or more transceivers 1030, the UE apparatus 1002 may include a Bluetooth module 1032, a WLAN module 1034, an SPS module 1036 (e.g., GNSS module), and/or a cellular module 1038. The Bluetooth module 1032, the WLAN module 1034, the SPS module 1036, and the cellular module 1038 may each include an on-chip transceiver (TRX), or in some cases, just a transmitter (TX) or just a receiver (RX). The Bluetooth module 1032, the WLAN module 1034, the SPS module 1036, and the cellular module 1038 may each include dedicated antennas and/or utilize antennas 1040 for communication with one or more other nodes. For example, the UE apparatus 1002 can communicate through the transceiver(s) 1030 via the antennas 1040 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1026 and the application processor 1006 may each include a computer-readable medium/memory 1026′, 1006′, respectively. The additional module of memory 1016 may also be considered a computer-readable medium/memory. Each computer-readable medium/memory 1026′, 1006′, 1016 may be non-transitory. The wireless baseband processor 1026 and the application processor 1006 may each be responsible for general processing, including execution of software stored on the computer-readable medium/memory 1026′, 1006′, 1016. The software, when executed by the wireless baseband processor 1026/application processor 1006, causes the wireless baseband processor 1026/application processor 1006 to perform the various functions described herein. The computer-readable medium/memory may also be used for storing data that is manipulated by the wireless baseband processor 1026/application processor 1006 when executing the software. The wireless baseband processor 1026/application processor 1006 may be a component of the UE 102. The UE apparatus 1002 may be a processor chip (e.g., modem and/or application) and include just the wireless baseband processor 1026 and/or the application processor 1006. In other examples, the UE apparatus 1002 may be the entire UE 102 and include the additional modules of the apparatus 1002.

As discussed in FIG. 1 and implemented with respect to FIG. 8, the beam tracking component 140 is configured to receive, from a network entity, a first SSB and a second SSB based on a same spatial-domain transmission filter; and communicate a signal with the network entity over a UE beam, a selection of the UE beam being based on a joint beam tracking procedure that includes a beam quality comparison of a first beam associated with the first SSB and a second beam associated with the second SSB. The beam tracking component 140 may be within the application processor 1006 (e.g., at 140a), the wireless baseband processor 1026 (e.g., at 140b), or both the application processor 1006 and the wireless baseband processor 1026. The beam tracking component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 11 is a diagram 1100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1146, which may have on-chip memory 1146′. In some aspects, the CU 110 may further include an additional module of memory 1156 and/or a communications interface 1148, both of which may be coupled to the CU processor 1146. The CU 110 can communicate with the DU 108 through a midhaul link 162, such as an F1 interface between the communications interface 1148 of the CU 110 and a communications interface 1128 of the DU 108.

The DU 108 may include a DU processor 1126, which may have on-chip memory 1126′. In some aspects, the DU 108 may further include an additional module of memory 1136 and/or the communications interface 1128, both of which may be coupled to the DU processor 1126. The DU 108 can communicate with the RU 106 through a fronthaul link 160 between the communications interface 1128 of the DU 108 and a communications interface 1108 of the RU 106.

The RU 106 may include an RU processor 1106, which may have on-chip memory 1106′. In some aspects, the RU 106 may further include an additional module of memory 1116, the communications interface 1108, and one or more transceivers 1130, all of which may be coupled to the RU processor 1106. The RU 106 may further include antennas 1140, which may be coupled to the one or more transceivers 1130, such that the RU 106 can communicate through the one or more transceivers 1130 via the antennas 1140 with the UE 102.

The on-chip memory 1106′, 1126′, 1146′ and the additional modules of memory 1116, 1136, 1156 may each be considered a computer-readable medium/memory. Each computer-readable medium/memory may be non-transitory. Each of the processors 1106, 1126, 1146 is responsible for general processing, including execution of software stored on the computer-readable medium/memory. The software, when executed by the corresponding processor(s) 1106, 1126, 1146 causes the processor(s) 1106, 1126, 1146 to perform the various functions described herein. The computer-readable medium/memory may also be used for storing data that is manipulated by the processor(s) 1106, 1126, 1146 when executing the software. In examples, the SSB/CSI-RS configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 9, the SSB/CSI-RS configuration component 150 is configured to transmit, to a UE, a first SSB and a second SSB based on a same spatial-domain transmission filter; and receive, from the UE, an indication of a UE beam for communicating with the network entity, the indication of the UE beam being based on a joint beam tracking procedure of a first beam associated with the first SSB and a second beam associated with the second SSB. The SSB/CSI-RS configuration component 150 may be within one or more processors of the one or more network entities 104, such as the RU processor 1106 (e.g., at 150a), the DU processor 1126 (e.g., at 150b), and/or the CU processor 1146 (e.g., at 150c). The SSB/CSI-RS configuration component 150a-150c may be one or more hardware components specifically configured to carry out the stated processes/algorithm, implemented by one or more processors 1106, 1126, 1146 configured to perform the stated processes/algorithm, stored within a computer-readable medium for implementation by the one or more processors 1106, 1126, 1146, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software_shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a first SSB and a second SSB based on a same spatial-domain transmission filter; and communicating a signal with the network entity over a UE beam, a selection of the UE beam being based on a joint beam tracking procedure that includes a beam quality comparison of a first beam associated with the first SSB and a second beam associated with the second SSB.

Example 2 may be combined with Example 1 and incudes that the receiving the first SSB and the second SSB based on the same spatial-domain transmission filter, further includes: receiving at least one of: the first SSB and a different SSB than the first SSB, the first SSB and a repetition of the first SSB, the repetition including a whole repetition of the first SSB or a partial repetition of the first SSB, or the first SSB and a CSI-RS.

Example 3 may be combined with Example 2 and includes that the joint beam tracking procedure, further includes: comparing the first SSB and at least one of: the different SSB than the first SSB, the repetition of the first SSB, or the CSI-RS, for the beam quality comparison of the first beam associated with the first SSB and the second beam associated with the second SSB, and includes that the receiving the first SSB and the second SSB further includes: receiving the first SSB and the second SSB with different UE beams.

Example 4 may be combined with any of Examples 1-3, further including transmitting, to the network entity, a UE capability report indicating a capability of the UE for the joint beam tracking procedure.

Example 5 may be combined with Example 4 and includes that the UE capability report indicates at least one of: whether the UE supports SSB repetitions for the joint beam tracking procedure, whether the UE supports the second SSB serving as a repetition of the first SSB for the joint beam tracking procedure, whether the UE supports SSB and CSI-RS receptions for the joint beam tracking procedure, a first minimum number of the SSB repetitions for a UE beam sweeping procedure, a second minimum number of CSI-RS resources for the UE beam sweeping procedure, whether the UE supports cross-CC SSB repetitions for the joint beam tracking procedure, or whether the UE supports cross-CC SSB and CSI-RS receptions for the joint beam tracking procedure.

Example 6 may be combined with any of Examples 1-5 and further includes receiving, from the network entity, a configuration for at least one of the first SSB or the second SSB of the joint beam tracking procedure.

Example 7 may be combined with Example 6 and includes that the configuration is for the second SSB to serve as a repetition of the first SSB.

Example 8 may be combined with Example 6 and includes that the configuration is for at least one of a CSI-RS resource or a CSI-RS resource set.

Example 9 may be combined with Example 8 and further includes receiving, from the network entity, a triggering indication for the configuration.

Example 10 may be combined with any of Examples 1-9 and further includes updating a TCI state of the UE beam based on the joint beam tracking procedure that includes the beam quality comparison of the first beam associated with the first SSB and the second beam associated with the second SSB.

Example 11 is a method of wireless communication at a network entity, including: transmitting, to a UE, a first SSB and a second SSB based on a same spatial-domain transmission filter; and receiving, from the UE, an indication of a UE beam for communicating with the network entity, the indication of the UE beam being based on a joint beam tracking procedure of a first beam associated with the first SSB and a second beam associated with the second SSB.

Example 12 may be combined with Example 11 and includes that the transmitting the first SSB and the second SSB based on the same spatial-domain transmission filter, further includes: transmitting at least one of: the first SSB and a different SSB than the first SSB, the first SSB and a repetition of the first SSB, the repetition including a whole repetition of the first SSB or a partial repetition of the first SSB, or the first SSB and a CSI-RS.

Example 13 may be combined with any of Examples 11-12 and further includes receiving, from the UE, a UE capability report indicating a capability of the UE for the joint beam tracking procedure.

Example 14 may be combined with Example 13 and includes that the UE capability report indicates at least one of: whether the UE supports SSB repetitions for the joint beam tracking procedure, whether the UE supports the second SSB serving as a repetition of the first SSB for the joint beam tracking procedure, whether the UE supports SSB and CSI-RS receptions for the joint beam tracking procedure, a first minimum number of the SSB repetitions for a UE beam sweeping procedure, a second minimum number of CSI-RS resources for the UE beam sweeping procedure, whether the UE supports cross-CC SSB repetitions for the joint beam tracking procedure, or whether the UE supports cross-CC SSB and CSI-RS receptions for the joint beam tracking procedure.

Example 15 may be combined with any of Examples 11-14 and further includes transmitting, to the UE, a resource configuration for at least one of the first SSB or the second SSB for the joint beam tracking procedure.

Example 16 may be combined with Example 15 and includes that the configuration is for the second SSB to serve as a repetition of the first SSB.

Example 17 may be combined with Example 15 and includes that the configuration is for at least one of a CSI-RS resource or a CSI-RS resource set.

Example 18 may be combined with Example 17 and further includes transmitting, to the UE, a triggering indication for the configuration.

Example 19 may be combined with any of Examples 11-18 and further includes transmitting, to the UE, a TCI state for the first beam associated with the first SSB and the second beam associated with the second SSB, the first beam being different from the second beam.

Example 20 is an apparatus for wireless communication for implementing a method as in any of examples 1-19.

Example 21 is an apparatus for wireless communication including means for implementing a method as in any of examples 1-19.

Example 22 is a non-transitory computer-readable medium storing computer executable code, the code when executed by a processor causes the processor to implement a method as in any of examples 1-19.

1. A method of wireless communication at a user equipment (UE), comprising:
receiving, from a network entity, control signaling that configures a first set of synchronization signal blocks (SSBs) and a second set of SSBs, the first set of SSBs and the second set of SSBs corresponding to a same SSB index;
receiving, from the network entity, a first synchronization signal block (SSB) of the first set of SSBs and a second SSB of the second set of SSBs based on a same spatial-domain transmission filter; and
communicating with the network entity over a UE beam, a selection of the UE beam being based on the first SSB and the second SSB.

2. The method of claim 1, wherein the receiving the first SSB and the second SSB based on the same spatial-domain transmission filter, further comprises:
receiving at least one of:
the first SSB and a different SSB than the first SSB,
the first SSB and a repetition of the first SSB, or
the first SSB and a channel state information-reference signal (CSI-RS).

3. The method of claim 2, wherein the selection of the UE beam is based on a joint beam tracking procedure comprising:
comparing the first SSB and at least one of: the different SSB than the first SSB, the repetition of the first SSB, or the CSI-RS, for a beam quality comparison of a first beam associated with the first SSB and a second beam associated with the second SSB, and wherein the receiving the first SSB and the second SSB further comprises:
receiving the first SSB and the second SSB with different UE beams.

4. The method of claim 3, further comprising:
transmitting, to the network entity, a UE capability report indicating a capability of the UE for the joint beam tracking procedure.

5. The method of claim 4, wherein the UE capability report indicates at least one of:
whether the UE supports SSB repetitions for the joint beam tracking procedure,
whether the UE supports the second SSB serving as a repetition of the first SSB for the joint beam tracking procedure,
whether the UE supports SSB and CSI-RS receptions for the joint beam tracking procedure,
a first minimum number of the SSB repetitions for a UE beam sweeping procedure,
a second minimum number of CSI-RS resources for the UE beam sweeping procedure,
whether the UE supports cross-component carrier (CC) SSB repetitions for the joint beam tracking procedure, or
whether the UE supports cross-CC SSB and CSI-RS receptions for the joint beam tracking procedure.

6. The method of claim 1, wherein the control signaling configures a periodicity of the second SSB, a location of the second SSB, and a number of repetitions of the second SSB.

7. The method of claim 1, wherein the control signaling is for the second SSB to serve as a repetition of the first SSB.

8. The method of claim 1, wherein the control signaling is for at least one of a channel state information-reference signal (CSI-RS) resource or a CSI-RS resource set.

9. The method of claim 1, further comprising:
receiving, from the network entity, a triggering indication for the control signaling.

10. The method of claim 1, further comprising:
updating a transmission configuration indicator (TCI) state of the UE beam based on a joint beam tracking procedure that includes a beam quality comparison of a first beam associated with a first SSB and a second beam associated with the second SSB.

11. A method of wireless communication at a network entity (104), comprising:
transmitting, to a user equipment (UE), control signaling that configures a first set of synchronization signal block (SSBs) and a second set of SSBs, the first set of SSBs and the second set of SSBs corresponding to a same SSB index;
transmitting, to the UE, a first SSB of the first set of SSBs and a second SSB of the second set of SSBs based on a same spatial-domain transmission filter; and
receiving, from the UE, an indication of a UE beam for communicating with the network entity, the indication of the UE beam being based on the first SSB and the second SSB.

12. The method of claim 11, wherein the transmitting the first SSB and the second SSB based on the same spatial-domain transmission filter, further comprises:
transmitting at least one of:
the first SSB and a different SSB than the first SSB,
the first SSB and a repetition of the first SSB, or
the first SSB and a channel state information-reference signal (CSI-RS).

13. The method of claim 11, further comprising:
receiving, from the UE, a UE capability report indicating a capability of the UE for a joint beam tracking procedure.

14. The method of claim 11, wherein the control signaling configures a periodicity of the second SSB, a location of the second SSB, and a number of repetitions of the second SSB.

15. An apparatus for wireless communication comprising:
a transceiver;
a memory; and
a processor coupled to the memory and the transceiver, the processor being configured to:
receive, from a network entity, control signaling that configures a first set of synchronization signal blocks (SSBs) and a second set of SSBs, the first set of SSBs and the second set of SSBs corresponding to a same SSB index;
receive, from the network entity, a first SSB of the first set of SSBs and a second SSB of the second set of SSBs based on a same spatial-domain transmission filter; and
communicate with the network entity over a user equipment (UE) beam, a selection of the UE beam being based on the first SSB and the second SSB.

16. The apparatus of claim 15, wherein the selection of the UE beam is based on a joint beam tracking procedure;
wherein the processor is further configured to perform the joint beam tracking procedure by comparing the first SSB and a repetition of the first SSB for a beam quality comparison of a first beam associated with the first SSB and the second SSB; wherein the processor configured to receive the first SSB and the second SSB is further configured to receive the first SSB and the second SSB with different UE beams.

17. The apparatus of claim 15, wherein the control signaling configures a periodicity of the second SSB, a location of the second SSB, and a number of repetitions of the second SSB.

18. The apparatus of claim 15, wherein a configuration for the second set of SSBs is received via at least one of:
a medium access control-control element (MAC-CE), or
downlink control information (DCI) using a groupcast message based on a radio network temporary identifier (RNTI).

19. The method of claim 1, wherein a configuration for the second set of SSBs is received via at least one of:
a medium access control-control element (MAC-CE), or
downlink control information (DCI) using a groupcast message based on a radio network temporary identifier (RNTI).

20. The method of claim 11, wherein a configuration for the second set of SSBs is transmitted via at least one of:
a medium access control-control element (MAC-CE), or
downlink control information (DCI) using a groupcast message based on a radio network temporary identifier (RNTI).
